(19) United States
(12) Patent Application Publication
(10) Pub. No.: US 2025/0378061 A1
(43) Pub. Date: Dec. 11, 2025

(54) Technologies for Writing Change Data in Real Time as a Transaction Occurs Using Multithreading

(71) Applicant: The PNC Financial Services Group, Inc., Pittsburgh, PA (US)

(72) Inventors: Kyle Joseph Jurick, Fort Wayne, IN (US); Benjamin Allen Hunsberger, Shipshewana, IN (US); John Cusey, Houston, TX (US); Poonam Deshmukh, Solon, OH (US); Luke M. Miller, Billings, MT (US)

(21) Appl. No.: 19/226,523

(22) Filed: Jun. 3, 2025

Related U.S. Application Data
(60) Provisional application No. 63/656,202, filed on Jun. 5, 2024.

(51) Int. Cl. G06F 16/23

(52) U.S. Cl. CPC G06F 16/2322; G06F 16/2365

(57) ABSTRACT

Technologies for writing change data in real time as a transaction occurs using multithreading include a compute device. The compute device includes circuitry configured to obtain transaction data indicative of transactions associated with threads of a multithreaded environment. The circuitry may be further configured to provide the transaction data to a staging table to prevent overwrites of data present in a target data set with older data. Additionally, the circuitry may be configured to selectively write data from the staging table to the target data set to reconstruct a chronological sequence associated with the transactions.

### RELATED APPLICATIONS

This application claims the benefit of U.S. Provisional Application No. 63/656,202 filed Jun. 5, 2024 for “Technologies for Writing Change Data in Real Time as a Transaction Occurs Using Multithreading,” which is hereby incorporated by reference in its entirety.

### BACKGROUND

In a complex environment in which updates to a database may be initiated from multiple sources concurrently and arrive at a destination (e.g., an endpoint) in a non-deterministic order (e.g., not necessarily in the order that the underlying events occurred), integrity of the data may be compromised. That is, a later-arriving update may represent older data than an earlier-arriving update that has already been received and written to the database. Left unchecked, the later-arriving update may overwrite the early-arriving update with stale data. Some systems may employ protective measures to guard against out of order writes to data sets. However, those measures typically result in processing delays that are unsuitable for high frequency or real time transaction updates. Further, such systems are typically restricted to use with data sets having a relatively rigid structure, rather than data sets with varying formats of structured, semi-structured, and unstructured data (e.g., data lakes).

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for writing changes to transaction data associated with multiple threads as the transactions occur;

FIG. 2 is a simplified block diagram of at least one embodiment of a compute device of the system of FIG. 1;

FIGS. 3-6 are simplified block diagrams of at least one embodiment of a method for writing changes to transaction data associated with multiple threads that may be executed by the system of FIG. 1;

FIG. 7 is a diagram of at least one embodiment of data provided to a staging table, to be selectively written to a target data set by the system of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

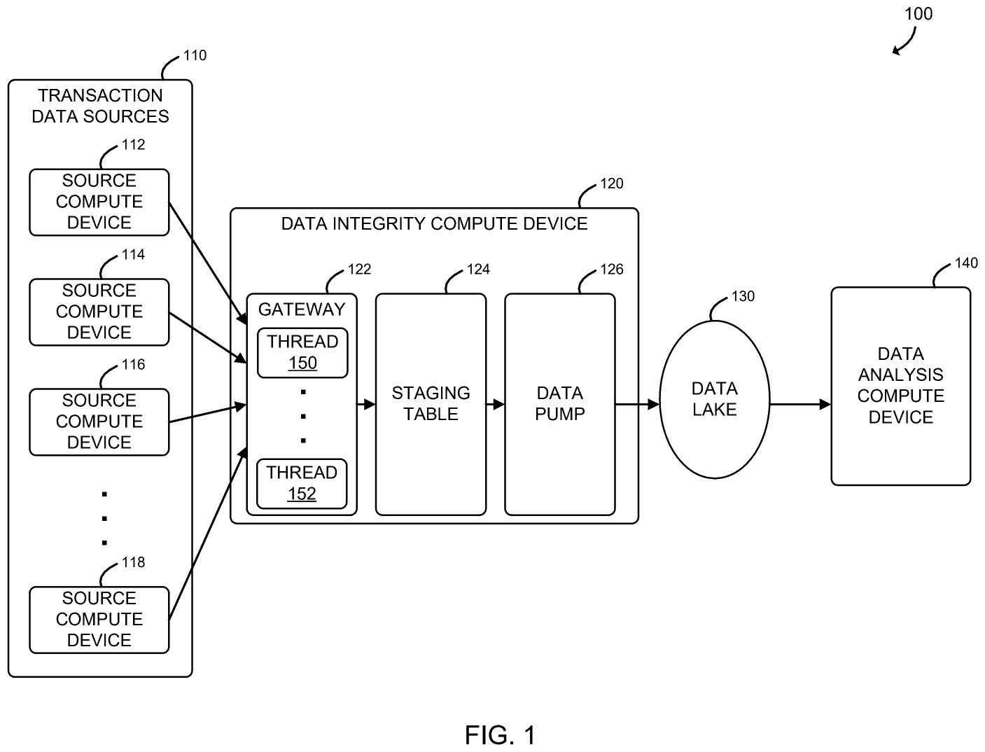

Referring now to FIG. 1, a system 100 for writing changes to transaction data associated with multiple threads as the transactions occur (e.g., in real time or near real time) includes a set of transaction data sources 110, a data integrity compute device 120, a data lake 130 (e.g., a target data set, which may be embodied as a repository of data in its original form (e.g., structured, unstructured, or semi-structured)), and a data analysis compute device 140. Depending on the embodiment, transaction data may be embodied as any time series data, such as sensor data indicative of changes to one or more physical characteristics of a physical item, data indicative of changes to objects represented in memory (e.g., changes to one or more properties of an instance of an object in an object-oriented software environment), data indicative of changes to a status of a transfer of funds between financial accounts, or the like. In the illustrative embodiment, the transaction data sources 110 include source compute devices 112, 114, 116, 118, each associated with a channel through which a transaction may be initiated or updated. In the illustrative embodiment, the source compute device 112, in operation, submits transaction data pertaining to web-based financial transactions (e.g., purchases initiated through e-commerce platforms accessed via a web browser or the like). Further, the source compute device 114, in operation, submits transaction data pertaining to mobile-based financial transactions (e.g., purchases initiated through applications executed on mobile compute devices, such as smart phones). The source compute device 116, in the illustrative embodiment, submits transaction data pertaining card present financial transactions (e.g., purchases made at a merchant's location, in which a customer physically presents a payment card (e.g., a credit card) for payment). The source compute device 118 may submit transaction data pertaining to any of the above channels or another channel. Although transaction data submitted by the source compute devices 112, 114, 116, 118 is described as being related to financial transactions for purposes of example, the term “transaction” is broadly intended to be interpreted as any type of computing transaction.

In the illustrative embodiment, the source compute devices 112, 114, 116, 118 submit transaction data to a gateway 122 of the data integrity compute device 120 through a network (not shown). In some embodiments, the source compute devices 112, 114, 116, 118 submit the transaction data to the gateway 122 using application programming interface (API) calls (e.g., representational state transfer (REST) API calls). The gateway 122 may be embodied as any circuitry, device, or process of the data integrity compute device 120 configured to obtain the transaction data from the source compute devices 112, 114, 116, 118 and write the transaction data to a staging table 124. In doing so, the gateway 122 may utilize multiple threads (e.g., sequences of operations that may be executed concurrently and independently managed by a scheduler) 150, 152 that listen (e.g., repeatedly check) for transaction data associated with the channels (e.g., on corresponding network port(s)) and, in response to receipt, write the transaction data to the staging table 124. Due to the concurrent nature of the threads (e.g., simultaneous execution) and non-deterministic order in which transaction data may be received (e.g., in which delays in network communication may cause an earlier set of transaction data to arrive later to the gateway 122 than a later set of transaction data), the data integrity compute device 120 may write transaction data to the staging table 124 out of order (e.g., not in the order in which the underlying events or updates actually occurred). As such, the data integrity compute device 120 executes a set of operations (e.g., the data pump 126, which may be embodied as a set of operations optimized for efficient transfer of data between locations) to selectively read records (e.g., rows) from the staging table 124 and provide (e.g., write) certain records to a target data set (e.g., the data lake) in an order that reduces the chance that stale (e.g., outdated) data overwrites data that is newer with regard to a given transaction, using millisecond precision, as described in more detail herein. As such, and unlike conventional systems that utilize structured query language (SQL)-based mechanisms or other conventional thread-safety mechanisms that introduce delays (e.g., locking of resources, compute intensive comparison operations, and the like) in writing data originating from multiple sources, the system 100 enables efficient intake of real time or near real time data from an environment in which transactions occur at high speed across multiple channels. In doing so, the system 100 preserves the integrity of the data (e.g., chronological order in which the underlying updates occurred), thereby enabling real time or near real time analysis operations (e.g., searching, reporting, etc.) on the data (e.g., by the data analysis compute device 140) as transactions occur.

While relatively few compute devices 112, 114, 116, 118, 120, 140 are shown in FIG. 1 for simplicity and clarity, it should be understood that the number of compute devices, in practice, may range in the tens, hundreds, thousands, or more. Likewise, it should be understood that the compute devices 112, 114, 116, 118, 120, 140 may be distributed differently or perform different roles than the configuration shown in FIG. 1. Further, though shown as separate compute devices 112, 114, 116, 118, 120, 140 in some embodiments, the functionality of one or more of the compute devices 112, 114, 116, 118, 120, 140 may be combined into fewer compute devices (the data integrity compute device 120 may be combined with the data analysis compute device 140) and/or distributed across more compute devices than those shown in FIG. 1 (e.g., the data integrity compute device 120 may comprise multiple compute devices and/or the data analysis compute device 140 may comprise any number of compute devices).

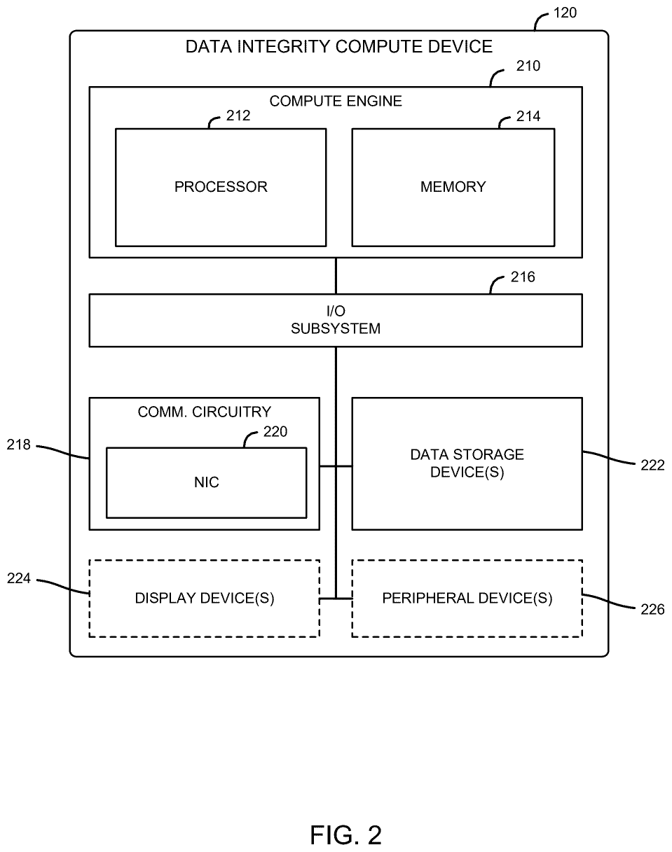

Referring now to FIG. 2, the illustrative data integrity compute device 120 includes a compute engine 210, an input/output (I/O) subsystem 216, communication circuitry 218, and one or more data storage devices 222. In some embodiments, the data integrity compute device 120 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as a processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the data integrity compute device 120 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding that a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as transaction data, applications, libraries, and drivers.

The compute engine 210 is communicatively coupled to other components of the data integrity compute device 120 via the I/O subsystem 216, which may be embodied as circuitry and/or components to facilitate input/output operations with the compute engine 210 (e.g., with the processor 212 and the main memory 214) and other components of the data integrity compute device 120. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the data integrity compute device 120, into the compute engine 210.

The communication circuitry 218 may be embodied as any communication circuit, device, or collection thereof, capable of enabling communications over a network between the data integrity compute device 120 and another device (e.g., a compute device 112, 114, 116, 118, 140, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the data integrity compute device 120 to connect with another compute device (e.g., a compute device 112, 114, 116, 118, 140, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the data integrity compute device 120 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the data integrity compute device 120 are housed in a single unit. However, in other embodiments, the components may be in separate housings, in separate racks of a data center, and/or spread across multiple data centers or other facilities. The compute devices 112, 114, 116, 118, 140 may have components similar to those described in FIG. 2 with reference to the data integrity compute device 120. The description of those components of the data integrity compute device 120 is equally applicable to the description of components of the compute devices 112, 114, 116, 118, 140. Further, it should be appreciated that any of the devices 112, 114, 116, 118, 120, 140 may include other components, sub-components, and devices commonly found in a computing device, which are not discussed above in reference to the data integrity compute device 120 and not discussed herein for clarity of the description.

In the illustrative embodiment, the compute devices 112, 114, 116, 118, 120, 140, are in communication via a network, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

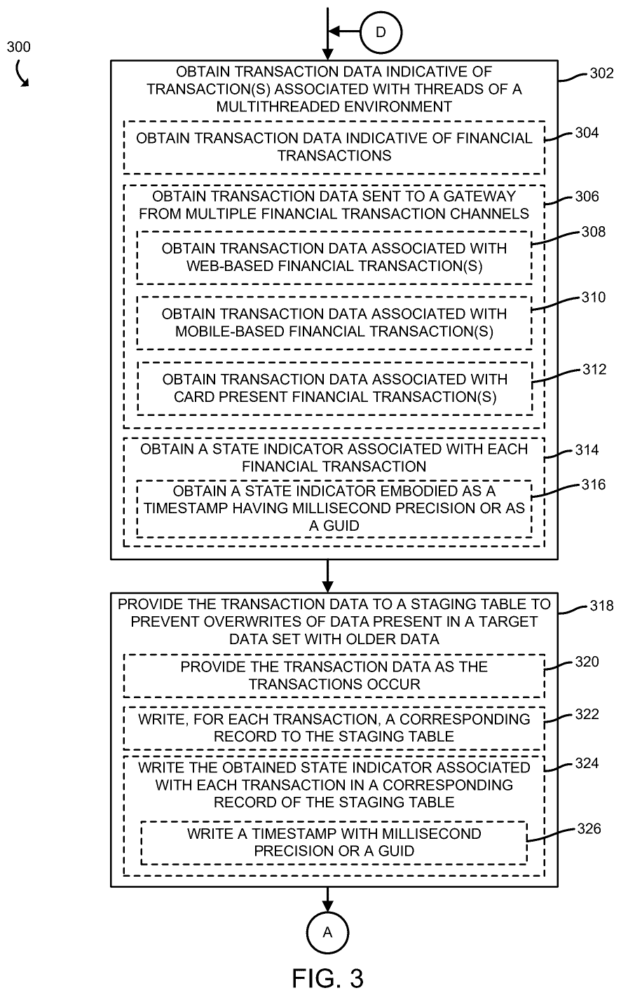

Referring now to FIG. 3, the system 100 (e.g., the data integrity compute device 120), in the illustrative embodiment, may perform a method 300 for writing changes to transaction data associated with multiple threads (e.g., the threads 150, 152) to enable low latency (e.g., real time or near real time) analysis of the data while maintaining the integrity of the data (e.g., avoiding out of order updates). The method 300 begins with block 302 in which the data integrity compute device 120 obtains transaction data indicative of transactions associated with threads of a multithreaded environment (e.g., associated with the threads 150, 152, which may receive transaction data sent to the data integrity compute device 120 (e.g., via API calls, with data formatted according to JavaScript Object Notation (JSON), extensible markup language (XML), and/or other formats) from the transaction data sources 110 (e.g., the source compute devices 112, 114, 116, 118). As indicated in block 304, in obtaining transaction data, the data integrity compute device 120 may obtain transaction data indicative of financial transactions. As indicated in block 306, in the illustrative embodiment, the data integrity compute device 120 obtains transaction data sent to a gateway (e.g., the gateway 122) from multiple financial transaction channels (e.g., “payment rails” or systems through which payments may be processed). In doing so, and as indicated in block 308, the data integrity compute device 120 may obtain transaction data associated with web-based financial transactions (e.g., financial transactions conducted through an e-commerce platform accessible through a web browser). Additionally or alternatively, the data integrity compute device 120 may obtain transaction data associated with mobile-based financial transactions (e.g., financial transactions conducted through an application associated with a mobile compute device, such as a smart phone), as indicated in block 310. Additionally or alternatively, the data integrity compute device 120 may obtain transaction data associated with card present financial transactions (e.g., financial transactions initiated from a merchant location in which the payor swipes, taps, or otherwise presents a payment card (e.g., a credit card, a debit card, etc.) to a point of sale device to initiate the financial transaction), as indicated in block 312.

In the illustrative embodiment, the data integrity compute device 120 obtains a state indicator, which may be embodied as any data indicative of (e.g., directly or indirectly) a chronological status of the transaction, as indicated in block 314. The state indicator, in the illustrative embodiment, is included in the data obtained from the corresponding data source 110 (e.g., the corresponding source compute device 112, 114, 116, 118). In some embodiments, the state indicator may be embodied as a transaction timestamp (e.g., any data, such as a sequence of characters or encoded information, indicative of when a corresponding event occurred) associated with each transaction. As indicated in block 316, the data integrity compute device 120 may obtain a state indicator as a timestamp having millisecond precision (e.g., identifies the time associated with the corresponding financial transaction data to the millisecond). In other embodiments, and as also indicated in block 316, the data integrity compute device 120 may obtain a globally unique identifier (GUID) from the source compute device 112, 114, 116, 118 that is indicative of a unique record in a data structure (e.g., a database table) from which the chronological placement of the transaction may be derived (e.g., based on the index or position of that record in the data structure (e.g., database table) relative to one or more other records in that data structure).

Continuing the method 300, in the illustrative embodiment, the data integrity compute device 120 provides the transaction data (e.g., from block 302) to a staging table (e.g., the staging table 124) to prevent overwrites of data that is already present in a target data set (e.g., not the staging table 124 itself, but a downstream target data set, such as the data lake 130) with older data, as indicated in block 318. That is, the data integrity compute device 120 performs the operation to prevent older data (e.g., data pertaining to an event relating to a transaction that occurred earlier in time) from overwriting newer data (e.g., data pertaining to an event relating to a transaction that occurred later in time).

The staging table 124 is illustratively embodied as a data structure that includes rows (e.g., records) and columns (e.g., corresponding to fields or properties associated with each record), but in other embodiments may have a different structure (e.g., a graph, a tree, etc.). As indicated in block 320, in the illustrative embodiment, the data integrity compute device 120 provides the transaction data (e.g., to the staging table 124) as the transactions occur (e.g., in real time or near real time). The data integrity compute device 120, in the illustrative embodiment, writes, for each transaction, a corresponding record to the staging table 124, as indicated in block 322. As indicated in block 324, the data integrity compute device 120 writes the obtained state indicator associated with each transaction in a corresponding record of the staging table 124. In doing so, and as indicated in block 326, the data integrity compute device 120 may write a timestamp with millisecond precision and/or a GUID that uniquely identifies the location of the data (e.g., the exact record in a source data table, from which the corresponding chronological placement of the data can be determined (e.g., based on the position of the record relative to other records in the source data table)).

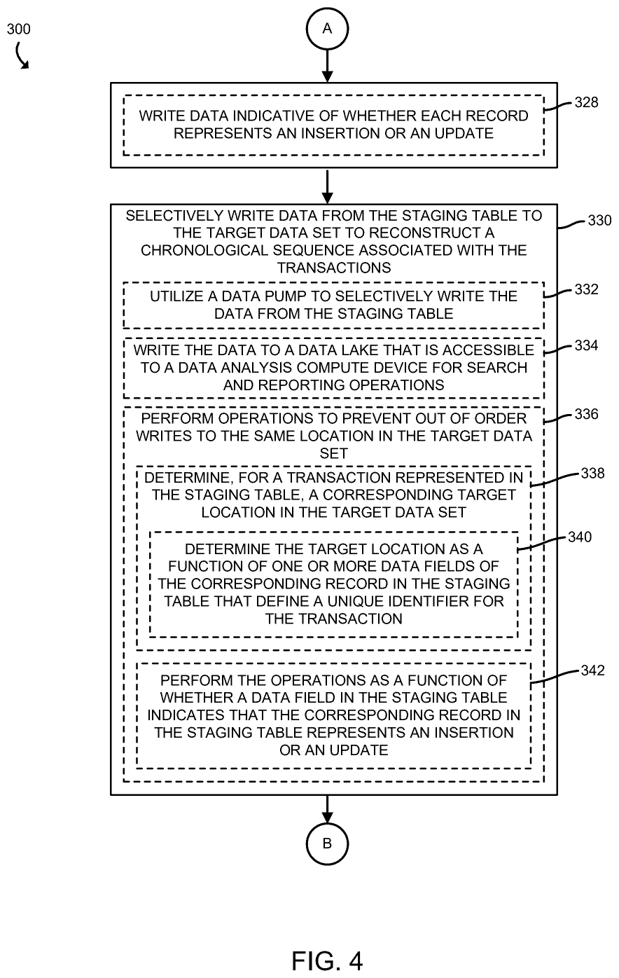

Referring now to FIG. 4, in block 328, in writing the records to the staging table 124, the data integrity compute device 120 writes data indicative of whether each record represents an insertion (e.g., a record indicative of a new transaction) or an update (e.g., a record indicative of an update to an existing transaction). Continuing the method 300, the data integrity compute device 120 selectively writes data from the staging table 124 to the target data set to reconstruct a chronological sequence associated with the transactions, as indicated in block 330. In doing so, the data integrity compute device 120 may utilize a data pump (e.g., the data pump 126) to selectively write the data from the staging table 124 (e.g., to the target data set), as indicated in block 332. In the illustrative embodiment, the data integrity compute device 120, in block 334, writes the data to a data lake (e.g., the data lake 130 is the target data set in the illustrative embodiment). As indicated in block 336, the data integrity compute device 120 performs operations to prevent out of order writes to the same location in the target data set (e.g., the data lake 130). In doing so, and as indicated in block 338, the data integrity compute device 120 may determine, for a transaction represented in the staging table 124, a corresponding target location in the target data set. As indicated in block 340, the data integrity compute device 120 may determine the target location as a function of one or more data fields (e.g., as a combination of multiple data fields) of the corresponding record in the staging table 124. The one or more fields may define a unique identifier for the corresponding transaction. In block 342, the data integrity compute device 120 may perform the operations as a function of whether a data field in the staging table 124 indicates that the corresponding record in the staging table 124 represents an insertion or an update. That is, the data integrity compute device 120, in the illustrative embodiment, performs different operations depending on whether the record in question from the staging table 124 represents an insertion or an update, as indicated by the data stored in block 328.

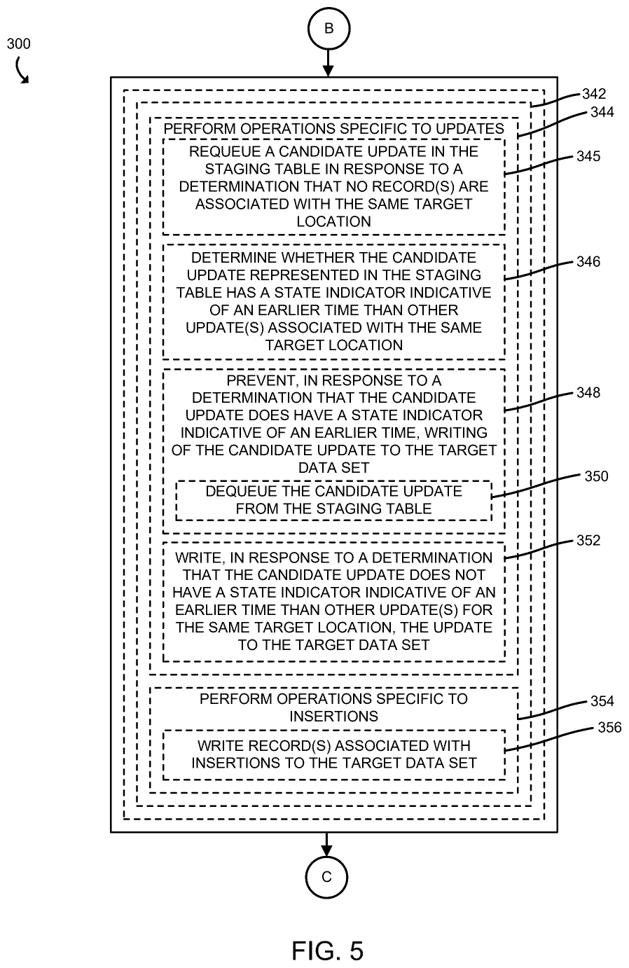

Referring now to FIG. 5, the data integrity compute device 120 may perform operations specific to updates (e.g., for records in the staging table 124 that are flagged as updates rather than insertions), as indicated in block 344. In some cases, the data integrity compute device 120 may perform operations on a candidate update prior to when there are any records in the same target location. In this situation, there is no record(s) to update because the insertion with the same target location has not yet been written to the target data set. Accordingly, when there is a determination that there are no record(s) associated with the same target location, the candidate update will be requeued (block 345), which may allow enough time to pass for the insertion to be written to the target location, and the next time this candidate update is queued for processing, the candidate update may be written to the target data set. The data integrity compute device 120 may determine whether a candidate update (e.g., an update under analysis by the data integrity compute device 120, to be potentially written to the target data set) represented in the staging table 124 has a state indicator indicative of an earlier time than other update(s) associated with the same target location (e.g., the target location in the target data set, as determined in block 338), as indicated in block 346. In block 348, in response to a determination that the candidate update does have a state indicator indicative of an earlier time than other updates for that same location in the target data set, the data integrity compute device 120 prevents that candidate update from being written to the target data set. In doing so, the data integrity compute device 120 may dequeue (e.g., remove) that candidate update from the staging table 124, as indicated in block 350. Conversely, in response to a determination that the candidate update does not have a state indicator that is indicative of an earlier time than other update(s) (e.g., in the staging table 124) for the same target location, the data integrity compute device 120 writes the candidate update to the target data (e.g., the data lake 130), as indicated in block 352. For insertions represented in the staging table, the data integrity compute device 120 performs operations specific to insertions, as indicated in block 354. In the illustrative embodiment, the data integrity compute device 120 writes data from records associated with insertions to the target data set (e.g., without performing state indicator comparisons), as indicated in block 356.

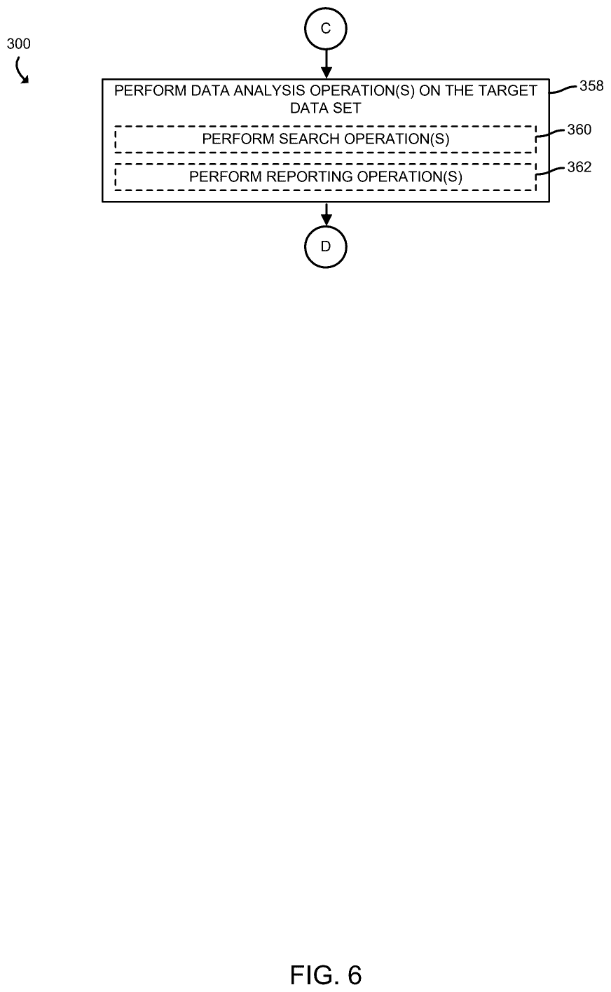

Referring now to FIG. 6, the system 100 may perform one or more data analysis operations on the target data set (e.g., the data lake 130), as indicated in block 358. In doing so, the system 100 may perform search operations (e.g., based on key words, natural language search, etc.), as indicated in block 360 and/or may perform reporting operations (e.g., summarization of data according to one or more parameters, such as a date range and/or search terms), as indicated in block 362. Though the operations of the method 300 are described in a particular sequence, it should be understood that in other embodiments, operations may be performed in a different order and/or in parallel.

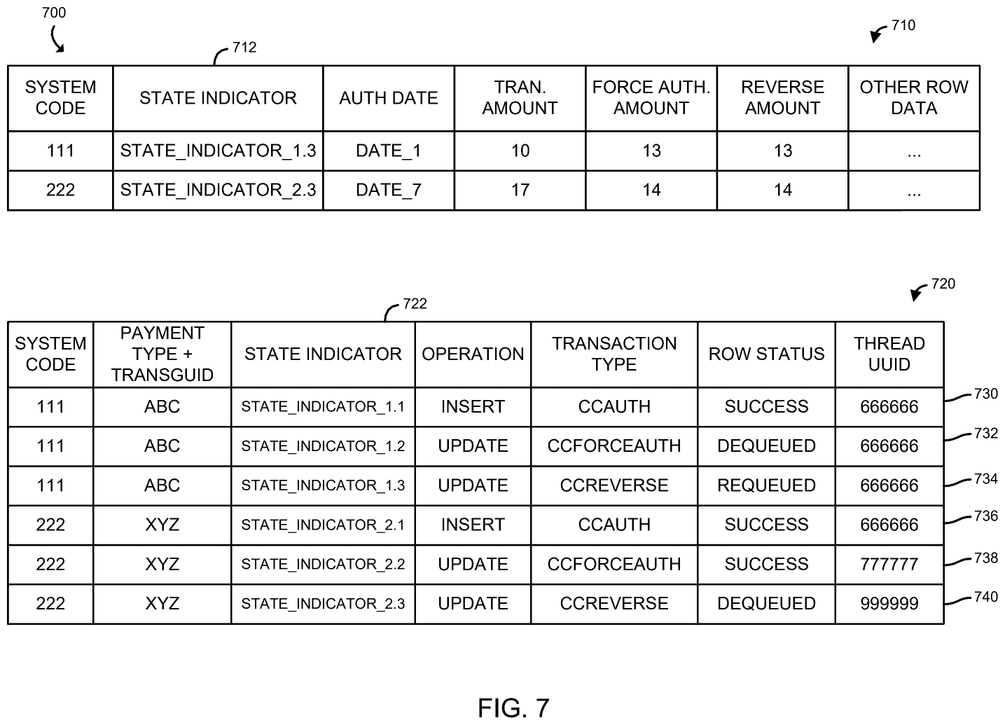

Referring now to the diagram 700 of FIG. 7, the data integrity compute device 120 may write transaction data 710 from a data source to a staging table 720 (e.g., corresponding to the staging table 124 of FIG. 1). In writing the data to the staging table 720, the data integrity compute device 120 may set a status field for each column as follows: The data integrity compute device 120 may set the status to “QUEUED” when inserting a row (e.g., record) into the staging table 720. Further, the data integrity compute device 120 may set the status to “INPROGRESS” once the data integrity compute device 120 pops off (e.g., reads) one or more rows (e.g., records) to be processed (e.g., using a corresponding thread). The data integrity compute device 120 may set the status to “PROCESSED” once the data integrity compute device 120 (e.g., using a corresponding thread) inserts or updates a row into the target data set (e.g., the data lake 130). Further, the data integrity compute device 120 may set the status to “QUEUED” or “REQUEUED” if a corresponding data structure (e.g., document) in the target data set (e.g., the data lake 130) is not present. In such a condition, the data integrity compute device 120, in the illustrative embodiment, holds the row (e.g., record) in the staging table 720 with the “QUEUED” or “REQUEUED” status. In response to a determination that a row (e.g., record) in the staging table 720 is stale (e.g., pertains to an update with a state indicator indicative of an earlier time than another update pertaining to the same transaction), the data integrity compute device 120 sets the status to “DISCARDED” (e.g., to prevent the data from being written to the target data set (e.g., the data lake 130)). In the illustrative embodiment, the state indicator column 712 of the transaction data table 710 maps to the state indicator column 722 of the staging table 720. Although the “Row Status” indicators, such as “Success,” “Dequeued,” “Requeued,” “Discarded,” “InProgress” are example indicators, the exact wording and function of these indicators could change depending on the circumstances.

Still referring to FIG. 7, in an example embodiment, with respect to the rows (e.g., records) 730, 736 the data integrity compute device 120 sends data from the rows (e.g., records) without comparing state indicators, as those rows pertain to insertions. Regarding row (e.g., record) 732, which pertains to an update, the data integrity compute device 120, in the example, compares the state_indicator_1.2 state indicator with the state_indicator_1.3 state indicator for the update in row (e.g., record) 734, determines that state_indicator_1.2 is indicative of an earlier time than state_indicator_1.3, and, accordingly, marks the row (e.g., record) 732 to be discarded or dequeued (e.g., not written to the target data set (e.g., the data lake 130)). The data integrity compute device 120, in the example embodiment, sets the status for row (e.g., record) 734 to “REQUEUED” because a corresponding data structure (e.g., document) in the target data set (e.g., data lake 130) is not present to be updated yet. Additionally, the data integrity compute device 120, in the example embodiment, sets the status of the row (e.g., record) 738 to “SUCCESS” because a corresponding data structure (e.g., document) was present in the target data set (e.g., data lake 130) to be updated, and as such, the data integrity compute device 120 (e.g., using the data pump 126) wrote the updated data to the data structure (e.g., document) in the target data set (e.g., the data lake 130). Further, in the example embodiment, the data integrity compute device 120 sets the status of the row (e.g., record) 740 to “DEQUEUED” to prevent the update from being written to the target data set (e.g., the data lake 130) based on a determination that the update contains stale data (e.g., based on a state indicator comparison).

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a compute device comprising circuitry configured to obtain transaction data indicative of transactions associated with threads of a multithreaded environment; provide the transaction data to a staging table to prevent overwrites of data present in a target data set with older data; and selectively write data from the staging table to the target data set to reconstruct a chronological sequence associated with the transactions.

Example 2 includes the subject matter of Example 1, and wherein to provide the transaction data to a staging table comprises to provide the transaction data as the transactions occur.

Example 3 includes the subject matter of any of Examples 1 and 2, and wherein to obtain transaction data comprises to obtain transaction data indicative of financial transactions.

Example 4 includes the subject matter of any of Examples 1-3, and wherein to obtain transaction data comprises to obtain data sent to a gateway from multiple financial transaction channels.

Example 5 includes the subject matter of any of Examples 1-4, and wherein to obtain transaction data sent to a gateway from multiple financial transaction channels comprises to obtain transaction data associated with web-based financial transactions, mobile-based financial transactions, or card present financial transactions.

Example 6 includes the subject matter of any of Examples 1-5, and wherein to obtain transaction data comprises to obtain a state indicator indicative of a chronological status associated with each financial transaction.

Example 7 includes the subject matter of any of Examples 1-6, and wherein to obtain a state indicator comprises to obtain a timestamp having millisecond precision or a globally unique identifier.

Example 8 includes the subject matter of any of Examples 1-7, and wherein to provide the transaction data comprises to write, for each transaction, a corresponding record to the staging table.

Example 9 includes the subject matter of any of Examples 1-8, and wherein to provide the transaction data comprises to write an obtained state indicator indicative of a chronological status associated with each financial transaction in the corresponding record of the staging table.

Example 10 includes the subject matter of any of Examples 1-9, and wherein to write an obtained state indicator comprises to write an obtained timestamp having millisecond precision or a globally unique identifier.

Example 11 includes the subject matter of any of Examples 1-10, and wherein to provide the transaction data comprises to write data indicative of whether each record represents an insertion or an update.

Example 12 includes the subject matter of any of Examples 1-11, and wherein to selectively write data from the staging table comprises to utilize a data pump to selectively write the data from the staging table to the target data set.

Example 13 includes the subject matter of any of Examples 1-12, and wherein to selectively write data from the staging table comprises to write the data to a data lake that is accessible to a compute device for search and reporting operations.

Example 14 includes the subject matter of any of Examples 1-13, and wherein to selectively write data from the staging table comprises to perform operations to prevent out of order writes to the same location in the target data set.

Example 15 includes the subject matter of any of Examples 1-14, and wherein to perform operations to prevent out of order writes to the same location in the target data set comprises to determine the target location as a function of one or more data fields of the corresponding record in the staging table that define a unique identifier for a transaction.

Example 16 includes the subject matter of any of Examples 1-15, and wherein to perform operations to prevent out of order writes comprises to perform the one or more operations as a function of whether a data field in the staging table indicates that the corresponding record represents an insertion or an update.

Example 17 includes the subject matter of any of Examples 1-16, and wherein to perform operations to prevent out of order writes to the same location comprises to determine whether a candidate update represented in the staging table has a state indicator indicative of an earlier time than one or more other updates in the staging table associated with the target location.

Example 18 includes the subject matter of any of Examples 1-17, and wherein the circuitry is further configured to prevent, in response to a determination that the candidate update does have a state indicator indicative of an earlier time, writing of the candidate update to the target data set.

Example 19 includes the subject matter of any of Examples 1-18, and wherein to prevent writing of the candidate update to the target data set comprises to dequeue the candidate update from the staging table.

Example 20 includes the subject matter of any of Examples 1-19, and wherein the circuitry is further configured to write, in response to a determination that the candidate update does not have a state indicator indicative of an earlier time, the candidate update to the target data set.

Example 21 includes the subject matter of any of Examples 1-20, and wherein to perform the one or more operations as a function of whether a data field in the staging table indicates that the corresponding record represents an insertion or an update comprises to write, for each record associated with an insertion, the record to the target data set.

Example 22 includes the subject matter of any of Examples 1-21, and wherein the circuitry is further configured to perform data analysis operations on the target data set.

Example 23 includes the subject matter of any of Examples 1-22, and wherein to perform data analysis operations comprises to perform one or more of search operations or reporting operations.

Example 24 includes a method comprising obtaining, by a compute device, transaction data indicative of transactions associated with threads of a multithreaded environment; providing, by the compute device, the transaction data to a staging table to prevent overwrites of data present in a target data set with older data; and selectively writing, by the compute device, data from the staging table to the target data set to reconstruct a chronological sequence associated with the transactions.

Example 25 includes the subject matter of Example 24, and wherein providing the transaction data to a staging table comprises providing the transaction data as the transactions occur.

Example 26 includes the subject matter of any of Examples 24 and 25, and wherein obtaining transaction data comprises obtaining transaction data indicative of financial transactions.

Example 27 includes the subject matter of any of Examples 24-26, and wherein obtaining transaction data comprises obtaining data sent to a gateway from multiple financial transaction channels.

Example 28 includes the subject matter of any of Examples 24-27, and wherein obtaining transaction data sent to a gateway from multiple financial transaction channels comprises obtaining transaction data associated with web-based financial transactions, mobile-based financial transactions, or card present financial transactions.

Example 29 includes the subject matter of any of Examples 24-28, and wherein obtaining transaction data comprises obtaining a state indicator indicative of a chronological status associated with each financial transaction.

Example 30 includes the subject matter of any of Examples 24-29, and wherein obtaining a state indicator comprises obtaining a timestamp having millisecond precision or a globally unique identifier.

Example 31 includes the subject matter of any of Examples 24-30, and wherein providing the transaction data comprises writing, for each transaction, a corresponding record to the staging table.

Example 32 includes the subject matter of any of Examples 24-31, and wherein providing the transaction data comprises writing an obtained state indicator indicative of a chronological status associated with each financial transaction in the corresponding record of the staging table.

Example 33 includes the subject matter of any of Examples 24-32, and wherein writing an obtained state indicator comprises writing an obtained timestamp having millisecond precision or a globally unique identifier.

Example 34 includes the subject matter of any of Examples 24-33, and wherein providing the transaction data comprises writing data indicative of whether each record represents an insertion or an update.

Example 35 includes the subject matter of any of Examples 24-34, and wherein selectively writing data from the staging table comprises utilizing a data pump to selectively write the data from the staging table to the target data set.

Example 36 includes the subject matter of any of Examples 24-35, and wherein selectively writing data from the staging table comprises writing the data to a data lake that is accessible to a compute device for search and reporting operations.

Example 37 includes the subject matter of any of Examples 24-36, and wherein selectively writing data from the staging table comprises performing operations to prevent out of order writes to the same location in the target data set.

Example 38 includes the subject matter of any of Examples 24-37, and wherein performing operations to prevent out of order writes to the same location in the target data set comprises determining the target location as a function of one or more data fields of the corresponding record in the staging table that define a unique identifier for a transaction.

Example 39 includes the subject matter of any of Examples 24-38, and wherein performing operations to prevent out of order writes comprises performing the one or more operations as a function of whether a data field in the staging table indicates that the corresponding record represents an insertion or an update.

Example 40 includes the subject matter of any of Examples 24-39, and wherein performing operations to prevent out of order writes to the same location comprises determining whether a candidate update represented in the staging table has a state indicator indicative of an earlier time than one or more other updates in the staging table associated with the target location.

Example 41 includes the subject matter of any of Examples 24-40, and further including preventing, by the compute device and in response to a determination that the candidate update does have a state indicator indicative of an earlier time, writing of the candidate update to the target data set.

Example 42 includes the subject matter of any of Examples 24-41, and wherein preventing writing of the candidate update to the target data set comprises dequeueing the candidate update from the staging table.

Example 43 includes the subject matter of any of Examples 24-42, and further including writing, by the compute device and in response to a determination that the candidate update does not have a state indicator indicative of an earlier time, the candidate update to the target data set.

Example 44 includes the subject matter of any of Examples 24-43, and wherein performing the one or more operations as a function of whether a data field in the staging table indicates that the corresponding record represents an insertion or an update comprises writing, for each record associated with an insertion, the record to the target data set.

Example 45 includes the subject matter of any of Examples 24-44, and further including performing, by the compute device, data analysis operations on the target data set.

Example 46 includes the subject matter of any of Examples 24-45, and wherein performing data analysis operations comprises performing one or more of search operations or reporting operations.

Example 47 includes one or more machine-readable storage media comprising a plurality of instructions stored thereon that, in response to being executed, cause a compute device to obtain transaction data indicative of transactions associated with threads of a multithreaded environment; provide the transaction data to a staging table to prevent overwrites of data present in a target data set with older data; and selectively write data from the staging table to the target data set to reconstruct a chronological sequence associated with the transactions.

Example 48 includes the subject matter of Example 47, and wherein to provide the transaction data to a staging table comprises to provide the transaction data as the transactions occur.

Example 49 includes the subject matter of any of Examples 47 and 48, and wherein to obtain transaction data comprises to obtain transaction data indicative of financial transactions.

Example 50 includes the subject matter of any of Examples 47-49, and wherein to obtain transaction data comprises to obtain data sent to a gateway from multiple financial transaction channels.

Example 51 includes the subject matter of any of Examples 47-50, and wherein to obtain transaction data sent to a gateway from multiple financial transaction channels comprises to obtain transaction data associated with web-based financial transactions, mobile-based financial transactions, or card present financial transactions.

Example 52 includes the subject matter of any of Examples 47-51, and wherein to obtain transaction data comprises to obtain a state indicator indicative of a chronological status associated with each financial transaction.

Example 53 includes the subject matter of any of Examples 47-52, and wherein to obtain a state indicator comprises to obtain a timestamp having millisecond precision or a globally unique identifier.

Example 54 includes the subject matter of any of Examples 47-53, and wherein to provide the transaction data comprises to write, for each transaction, a corresponding record to the staging table.

Example 55 includes the subject matter of any of Examples 47-54, and wherein to provide the transaction data comprises to write an obtained state indicator indicative of a chronological status associated with each financial transaction in the corresponding record of the staging table.

Example 56 includes the subject matter of any of Examples 47-55, and wherein to write an obtained state indicator comprises to write an obtained timestamp having millisecond precision or a globally unique identifier.

Example 57 includes the subject matter of any of Examples 47-56, and wherein to provide the transaction data comprises to write data indicative of whether each record represents an insertion or an update.

Example 58 includes the subject matter of any of Examples 47-57, and wherein to selectively write data from the staging table comprises to utilize a data pump to selectively write the data from the staging table to the target data set.

Example 59 includes the subject matter of any of Examples 47-58, and wherein to selectively write data from the staging table comprises to write the data to a data lake that is accessible to a compute device for search and reporting operations.

Example 60 includes the subject matter of any of Examples 47-59, and wherein to selectively write data from the staging table comprises to perform operations to prevent out of order writes to the same location in the target data set.

Example 61 includes the subject matter of any of Examples 47-60, and wherein to perform operations to prevent out of order writes to the same location in the target data set comprises to determine the target location as a function of one or more data fields of the corresponding record in the staging table that define a unique identifier for a transaction.

Example 62 includes the subject matter of any of Examples 47-61, and wherein to perform operations to prevent out of order writes comprises to perform the one or more operations as a function of whether a data field in the staging table indicates that the corresponding record represents an insertion or an update.

Example 63 includes the subject matter of any of Examples 47-62, and wherein to perform operations to prevent out of order writes to the same location comprises to determine whether a candidate update represented in the staging table has a state indicator indicative of an earlier time than one or more other updates in the staging table associated with the target location.

Example 64 includes the subject matter of any of Examples 47-63, and wherein the instructions additionally cause the compute device to prevent, in response to a determination that the candidate update does have a state indicator indicative of an earlier time, writing of the candidate update to the target data set.

Example 65 includes the subject matter of any of Examples 47-64, and wherein to prevent writing of the candidate update to the target data set comprises to dequeue the candidate update from the staging table.

Example 66 includes the subject matter of any of Examples 47-65, and wherein the instructions additionally cause the compute device to write, in response to a determination that the candidate update does not have a state indicator indicative of an earlier time, the candidate update to the target data set.

Example 67 includes the subject matter of any of Examples 47-66, and wherein to perform the one or more operations as a function of whether a data field in the staging table indicates that the corresponding record represents an insertion or an update comprises to write, for each record associated with an insertion, the record to the target data set.

Example 68 includes the subject matter of any of Examples 47-67, and wherein the instructions additionally cause the compute device to perform data analysis operations on the target data set.

Example 69 includes the subject matter of any of Examples 47-68, and wherein to perform data analysis operations comprises to perform one or more of search operations or reporting operations.

1. A compute device comprising:
circuitry configured to:
obtain transaction data indicative of transactions associated with threads of a multithreaded environment, wherein to obtain transaction data comprises to obtain a state indicator indicative of a chronological status associated with each transaction;
provide the transaction data to a staging table to prevent overwrites of data present in a target data set with older data; and
selectively write data from the staging table to the target data set to reconstruct a chronological sequence associated with the transactions based on the state indicator.

2. The compute device of claim 1, wherein to provide the transaction data comprises to write an obtained state indicator indicative of a chronological status associated with each transaction in the corresponding record of the staging table.

3. The compute device of claim 2, wherein to write an obtained state indicator comprises to write an obtained timestamp having millisecond precision or a globally unique identifier.

4. The compute device of claim 3, wherein to provide the transaction data comprises to write data indicative of whether each record represents an insertion or an update.

5. The compute device of claim 1, wherein to selectively write data from the staging table comprises to perform operations to prevent out of order writes to the same location in the target data set.

6. The compute device of claim 5, wherein to perform operations to prevent out of order writes to the same location in the target data set comprises to determine the target location as a function of one or more data fields of the corresponding record in the staging table that define a unique identifier for a transaction.

7. The compute device of claim 6, wherein to perform operations to prevent out of order writes comprises to perform the one or more operations as a function of whether a data field in the staging table indicates that the corresponding record represents an insertion or an update.

8. The compute device of claim 7, wherein to perform operations to prevent out of order writes to the same location comprises to requeue a candidate update represented in the staging table in response to a determination that no records are associated with the target location.

9. The compute device of claim 7, wherein to perform operations to prevent out of order writes to the same location comprises to determine whether a candidate update represented in the staging table has a state indicator indicative of an earlier time than one or more other updates in the staging table associated with the target location.

10. The compute device of claim 9, wherein the circuitry is further configured to prevent, in response to a determination that the candidate update does have a state indicator indicative of an earlier time, writing of the candidate update to the target data set.

11. The compute device of claim 10, wherein to prevent writing of the candidate update to the target data set comprises to dequeue the candidate update from the staging table.

12. The compute device of claim 9, wherein the circuitry is further configured to write, in response to a determination that the candidate update does not have a state indicator indicative of an earlier time, the candidate update to the target data set.

13. The compute device of claim 7, wherein to perform the one or more operations as a function of whether a data field in the staging table indicates that the corresponding record represents an insertion or an update comprises to write, for each record associated with an insertion, the record to the target data set.

14. A method comprising:
obtaining, by a compute device, transaction data indicative of transactions associated with threads of a multithreaded environment, wherein obtaining transaction data comprises obtaining a state indicator indicative of a chronological status associated with each transaction;
providing, by the compute device, the transaction data to a staging table to prevent overwrites of data present in a target data set with older data; and
selectively writing data, by the compute device, from the staging table to the target data set to reconstruct a chronological sequence associated with the transactions based on the state indicator.

15. The method of claim 14, wherein providing the transaction data comprises writing an obtained state indicator indicative of a chronological status associated with each transaction in the corresponding record of the staging table.

16. The method of claim 15, wherein writing an obtained state indicator comprises to write an obtained timestamp having millisecond precision or a globally unique identifier.

17. The method of claim 16, wherein providing the transaction data comprises writing data indicative of whether each record represents an insertion or an update.

18. The method of claim 14, wherein selectively writing data from the staging table comprises to perform operations to prevent out of order writes to the same location in the target data set.

19. The method of claim 18, wherein performing operations to prevent out of order writes to the same location in the target data set comprises determining the target location as a function of one or more data fields of the corresponding record in the staging table that define a unique identifier for a transaction.

20. The method of claim 19, wherein performing operations to prevent out of order writes comprises performing the one or more operations as a function of whether a data field in the staging table indicates that the corresponding record represents an insertion or an update.

21. The method of claim 20, wherein performing operations to prevent out of order writes to the same location comprises requeuing a candidate update represented in the staging table in response to a determination that no records are associated with the target location.

22. The method of claim 20, wherein performing operations to prevent out of order writes to the same location comprises determining whether a candidate update represented in the staging table has a state indicator indicative of an earlier time than one or more other updates in the staging table associated with the target location.

23. The method of claim 22, further comprising preventing, in response to a determination that the candidate update does have a state indicator indicative of an earlier time, writing of the candidate update to the target data set.

24. The method of claim 23, wherein preventing writing of the candidate update to the target data set comprises dequeuing the candidate update from the staging table.

25. The method of claim 22, further comprising writing, in response to a determination that the candidate update does not have a state indicator indicative of an earlier time, the candidate update to the target data set.

26. The method of claim 20, wherein performing the one or more operations as a function of whether a data field in the staging table indicates that the corresponding record represents an insertion or an update comprises to write, for each record associated with an insertion, the record to the target data set.
